(19) United States
(12) Patent Application Publication
(10) Pub. No.: US 2007/0201683 A1
(43) Pub. Date: Aug. 30, 2007

(54) Telephone apparatus

(75) Inventors: Toshinori Saiin, Miyagi (JP); Tsuyoshi Ueno, Kanagawa (JP)

Correspondence Address: PEARNE & GORDON LLP, 1801 EAST 9TH STREET, SUITE 1200, CLEVELAND, OH, 44114-3108, US

(73) Assignee: Matsushita Electric Industrial Co., Ltd., Kadoma-shi, Osaka (JP)

(21) Appl. No.: 10/598,612

(22) PCT Filed: Jun. 2, 2005
(86) PCT No.: PCT/JP05/10155

§ 371 Date: Sep. 6, 2006

(30) Foreign Application Priority Data
Jun. 4, 2004 (JP) 2004-167449

(51) Int. Cl. H04M 1/00; H04M 3/00

(52) U.S. Cl. 379/360

(57) ABSTRACT

It is a problem of the invention to provide a telephone device in which only a terminal possessed by a user who wishes to identify a call partner is provided with a function of identifying the call partner, whereby the call partner can be always identified without troubling the call partner, and without making the call partner conscious of the judgment. The telephone device of the invention comprises: a storing section 18 which stores a voice of each of speakers; a speaker verifying section 15 which verifies the voice of each of speakers with a voice of a call partner; and a user notifying section 19 which notifies of the speaker who coincides with the voice of the call partner by the speaker verifying section 15.

### TECHNICAL FIELD

The present invention relates to a telephone device which can identify a call partner.

### BACKGROUND ART

Recently, as a method of identifying a call partner in a telephone device such as a mobile telephone or a fixed telephone, a method is known in which a called terminal searches previously registered telephone directory data for a calling telephone number, and an owner of a telephone device corresponding to the calling telephone number is notified to the user. According to the method, identification of a call partner is made under assumption that the call partner is identical with the owner of the telephone device, and it is possible to identify the telephone device of the call partner rather than the call partner.

However, the owner of a telephone device which is notified by the above-described related telephone device is mere reference information which is used by the user for identifying the call partner. Usually, the user actually hears the voice of the call partner to make a determination of whether the call partner is the owner of the calling telephone device. Consequently, there is a problem in that, when the voice of the call partner is similar to that of the owner of the telephone device, it is difficult to correctly identify the call partner. Incidentally, crimes in which a malicious person using a mobile telephone or a fixed telephone deceives a partner with assuming the name of a person and using a voice similar to the person are recently rapidly increased. Particularly, an elderly person or a hearing-impaired person is easily involved in such a problem.

Therefore, a communication system has been proposed in which it is possible to check whether the user of a mobile terminal such as a mobile telephone is the owner of the terminal or not, with using biological information of a call partner (for example, see Patent Reference 1). In the communication system, a calling terminal judges whether the user of the terminal is the owner of the terminal or not, based on the biological information (a fingerprint, a voiceprint, or the like), and sends information indicative of transmission from the owner of the terminal, to the called person. On the other hands, the called terminal which receives the information can identify that the calling person is the owner of the terminal.

Patent Reference 1: JP-A-2002-32343

### DISCLOSURE OF THE INVENTION

### Problems that the Invention is to Solve

In the communication system disclosed in Patent Reference 1, however, the calling terminal must be provided with a function of judging whether the user of the terminal is the owner of the terminal or not, based on biological information, and that of transmitting a result of the judgment, and the called terminal must be provided with a function of receiving the result of the judgment. In the case where one of the calling terminal and the called terminal is not provided with such a function, therefore, the called person cannot identify the calling person, and telephone devices which can use the communication system are limited.

In the communication system disclosed in Patent Reference 1, in order to enable the called person to identify the calling person as the owner of the terminal, the calling person must undergo judgment inspection using biological information, prior to the call. As a result, the calling person has a trouble, and the calling person is made conscious of the judgment inspection.

The invention has been conducted in view of the problems of the related art. It is an object of the invention to provide a telephone device in which the call partner can be correctly identified without providing both calling and called terminals with the function of identifying the call partner, and without troubling the call partner.

### Means for Solving the Problems

The telephone device of the invention comprises: a storing unit configured to store a voice of each of speakers; a speaker collating unit that verifies the voice of each of speakers with a voice of a call partner; and a notifying unit that notifies of the speaker who coincides with the voice of the call partner by the speaker verifying unit.

In order to enable a called terminal to identify a call partner, relatedly, a calling terminal is provided with a function of identifying the calling person as the owner of a calling terminal, and a called terminal is provided with a function of receiving from the calling terminal information indicating that the calling person is the owner of the calling terminal. In the case where one of the terminals is not provided with the function, the called terminal cannot identify the call partner. According to the configuration, only a terminal possessed by a user who wishes to identify the call partner is provided with the function of identifying the call partner. Therefore, the call partner can be always identified without troubling the call partner, and without making the call partner conscious of the judgment.

In the telephone device of the invention, the storing unit stores the voice of each of speakers so as to correspond to a telephone number. The speaker verifying unit verifies the voice of each of speakers corresponding to a telephone number of the call partner, with the voice of the call partner.

According to the configuration, only the voice of the speaker corresponding to the telephone number of the call partner is collated with the voice of the call partner, whereby the call partner can be efficiently identified.

In the telephone device of the invention, the storing unit stores the voice of the call partner as the voice of each of speakers so as to correspond to the telephone number of the call partner.

According to the configuration, the voice of the call partner is stored as the voice of each of speakers during the call, whereby a voice of each of new speakers can be stored without previously taking a trouble of directly storing a voice of each of speakers from the speaker oneself.

The telephone device of the invention further comprises a voice analyzing unit that extracts a featured portion from the voice of the call partner. The storing unit stores a featured portion of the voice of the call partner as a featured portion of the voice of each of speakers so as to correspond to the telephone number of the call partner. The speaker verifying unit verifies the featured portion of the voice of each of speakers corresponding to the telephone number of the call partner, with the featured portion of the voice of the call partner.

According to the configuration, only a feature which is required in verification is extracted from the voice of the call partner, whereby the capacity of data to be stored in the storing unit can be reduced, and the time required in verification by the speaker verifying unit can be shortened.

In the telephone device of the invention, the speaker verifying unit includes: an input voice calculating section that calculates a likelihood of the featured portion of the voice of the call partner on the basis of the featured portion of the voice of each of speakers; and a judging section that judges whether the featured portion of the voice of each of speakers coincides with the featured portion of the voice of the call partner, based on a result of the calculation.

According to the configuration, on the basis of the stored featured portion of the voice of each of speakers, the likelihood of the featured portion of the voice of the call partner is calculated, whereby an accurate result of verification can be obtained.

### EFFECTS OF THE INVENTION

According to the telephone device of the invention, the call partner can be correctly identified without providing both calling and called terminals with the function of identifying the call partner, without troubling the call partner, and without making the call partner conscious of the judgment.

### BRIEF DESCRIPTION OF THE DRAWINGS

FIG. 1 is a block diagram schematically showing the configuration of a mobile terminal of a first embodiment.

FIG. 2 is a block diagram schematically showing the configuration of a speaker verifying section in FIG. 1.

FIG. 3 is a flowchart showing the operation of the speaker verifying section in FIG. 1.

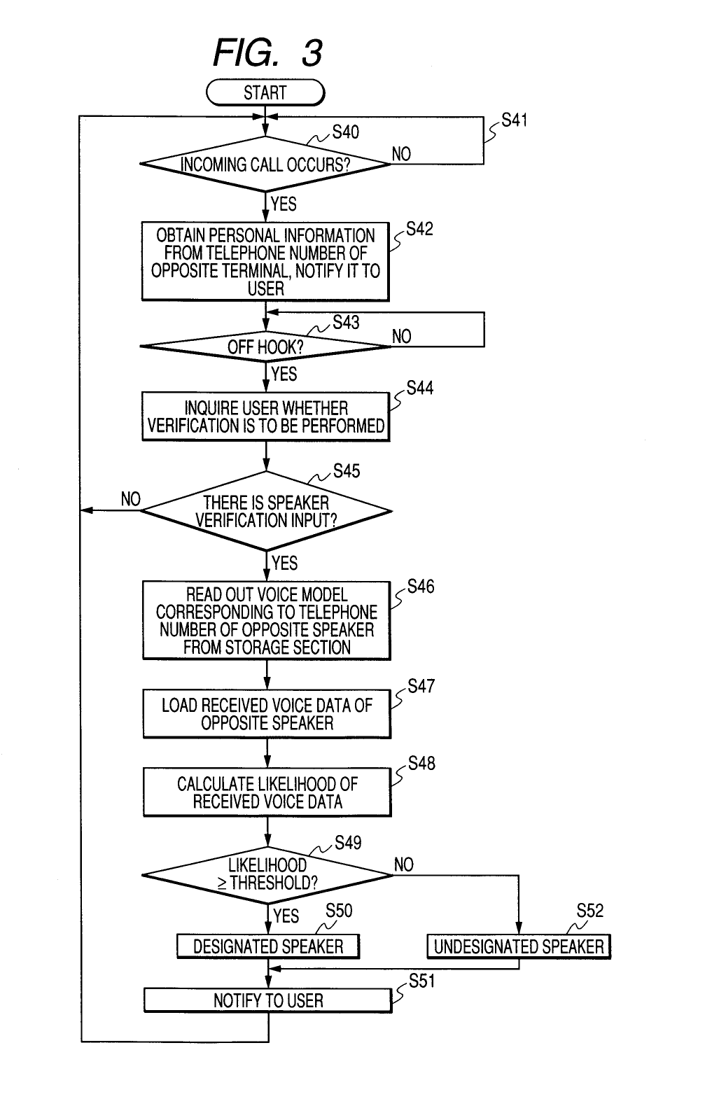

FIG. 4 is a block diagram schematically showing the configuration of a mobile telephone of a second embodiment.

FIG. 5 is a flowchart showing a speaker collating process in the mobile telephone of FIG. 4.

### DESCRIPTION OF REFERENCE NUMERALS AND SIGNS

11 antenna
12 transmitting and receiving section
13 voice processing section
14 loudspeaker
15 speaker verifying section
16 controlling section
17 inputting section
18 storage section
19 user notifying section
21 voice analyzing section
22 input voice calculating section
23 judging section
41 voice model learning section

### BEST MODE FOR CARRYING OUT THE INVENTION

Embodiments of the invention will be described in detail with reference to the drawings.

### First Embodiment

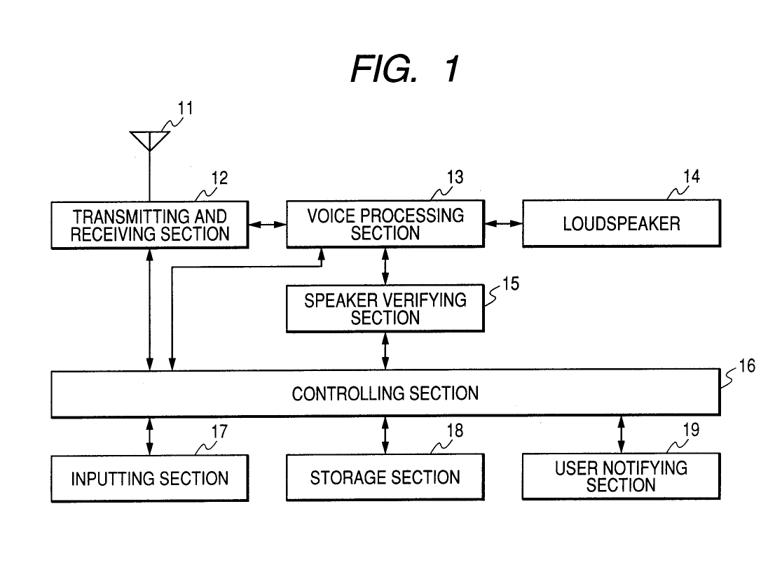

FIG. 1 is a block diagram schematically showing the configuration of a mobile terminal of a first embodiment of the invention.

The mobile terminal of the embodiment includes an antenna 11, a transmitting and receiving section 12, a voice processing section 13, a loudspeaker 14, a speaker verifying section 15, a controlling section 16, an inputting section 17, a storage section 18, and a user notifying section 19, and particularly has a function of identifying a call partner by speaker verification.

The antenna 11 is used for transmitting and receiving a radio signal. The transmitting and receiving section 12 transmits and receives a voice signal and packet data to and from a base station (not shown) by a modulation method which is agreed between the base station and the terminal. The voice processing section 13 converts the voice signal received by the transmitting and receiving section 12, to a voice signal which can be output from the loudspeaker 14, and also to voice data which, when identifying the call partner, can be collated by the speaker verifying section 15. The speaker verifying section 15 executes speaker verification with using the collatable voice data which are input from the voice processing section 13, and a voice model which is obtained from the storage section 18 through the controlling section 16.

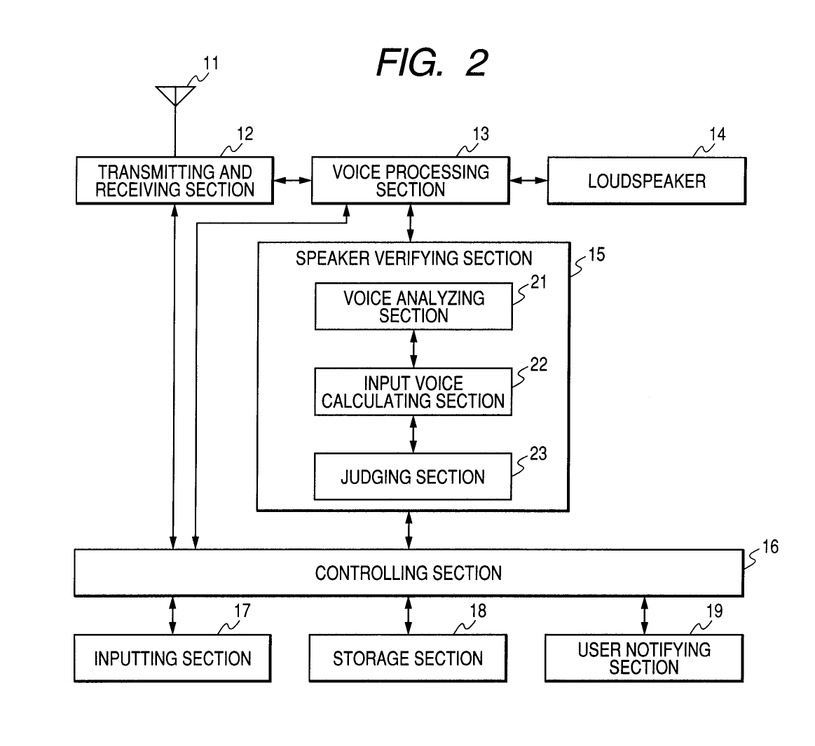

In order to describe the difference between the collatable voice data which are input from the voice processing section 13, and the voice model which is obtained from the storage section 18, the speaker verifying section 15 will be described in detail. As shown in the block diagram of FIG. 2 schematically showing the configuration of the speaker verifying section, the speaker verifying section 15 is configured by a voice analyzing section 21, an input voice calculating section 22, and a judging section 23. The voice analyzing section 21 extracts feature data which are required in production of a voice model, from the collatable voice data which are input from the voice processing section 13, and inputs the data into the input voice calculating section 22. On the basis a voice model of each of speakers stored in the storage section 18, the input voice calculating section 22 calculates a likelihood of a voice model produced from the input feature data. The judging section 23 compares a result of the likelihood calculation of the input voice calculating section 22 with a threshold which is previously stored correspodingly with the voice model of each of speakers, to judge whether the call partner is the owner of the opposite mobile terminal or not.

Referring back to FIG. 1, the controlling section 16 searches telephone directory data stored in the storage section 18 for the telephone number notified by the opposite mobile telephone, and reads out corresponding personal information, and the user notifying section 19 notifies the user of the own mobile terminal of the personal information input from the controlling section 16. The user of the own mobile terminal who is notified of the personal information operates the terminal so as to reply to the incoming call. When the incoming call is to be replied, for example, an off hook button (not shown) is pressed.

When the user of the own mobile terminal replies to the incoming call, the controlling section 16 inquires the user whether the call partner is collated through the user notifying section 19. When the user makes a request for starting speaker verification in response to the inquiry, the controlling section 16 searches voice models of respective speakers stored in the storage section 19, for existence of a voice model of a speaker corresponding to the telephone number of the opposite mobile terminal. If a voice model of a speaker corresponding to the telephone number of the opposite mobile terminal exists, the controlling section 16 instructs the speaker verifying section 15 to start speaker verification, and the voice processing section 13 to start speaker verification, and inputs the voice model of the speaker corresponding to the telephone number of the opposite mobile terminal stored in the storage section 18. By contrast, if a voice model of a speaker corresponding to the telephone number of the opposite mobile terminal does not exist, the controlling section 16 notifies the user of the present mobile terminal that speaker verification cannot be performed, through the user notifying section 19. Alternatively, the inquiry to the user of the own mobile terminal whether the call partner is collated may not be conducted, and automatic verification may be performed.

When instructed to start speaker verification by the controlling section 16, the voice processing section 13 converts a voice signal which is received by the transmitting and receiving section 12 during the call, to voice data which can be collated by the speaker verifying section 15, and inputs the data into the speaker verifying section 15. After the instructions for starting speaker verification, the speaker verifying section 15 calculates the likelihood of a voice model produced from the voice data input from the voice processing section 13, on the basis of the voice model of the speaker corresponding to the telephone number of the opposite mobile terminal which is obtained from the voice processing section 13. The speaker verifying section 15 compares a result of the calculation of the likelihood with a previously set threshold for each of speakers, determines whether the voice data input from the voice processing section 13 are accepted as voice data of the speaker corresponding to the telephone number of the opposite mobile terminal or rejected, and inputs the determination as the result of verification into the controlling section 16.

Upon receiving the result of verification, the controlling section 16 notifies the user whether the current call partner is the owner of the opposite mobile terminal or not, through the user notifying section 19. The user checks the notification. When the voice data are to be rejected, the user presses an on hook button to disconnect the line, and, when the voice data are to be accepted, the user continues the communication without performing any further operation.

The inputting section 17 is an inputting device typified by a button, and notifies the user's intention whether speaker verification is to be performed or not, or whether a voice model is to be produced or not, to the controlling section 16. The storage section 18 stores the telephone directory data including telephone number information and personal information, and voice models of respective speakers which are used in speaker verification in the present mobile terminal. The user notifying section 19 notifies the presence or absence of a voice model corresponding to the call partner, and a result of verification to the user, and a display such as a liquid crystal panel or an organic EL panel is usually used as the portion.

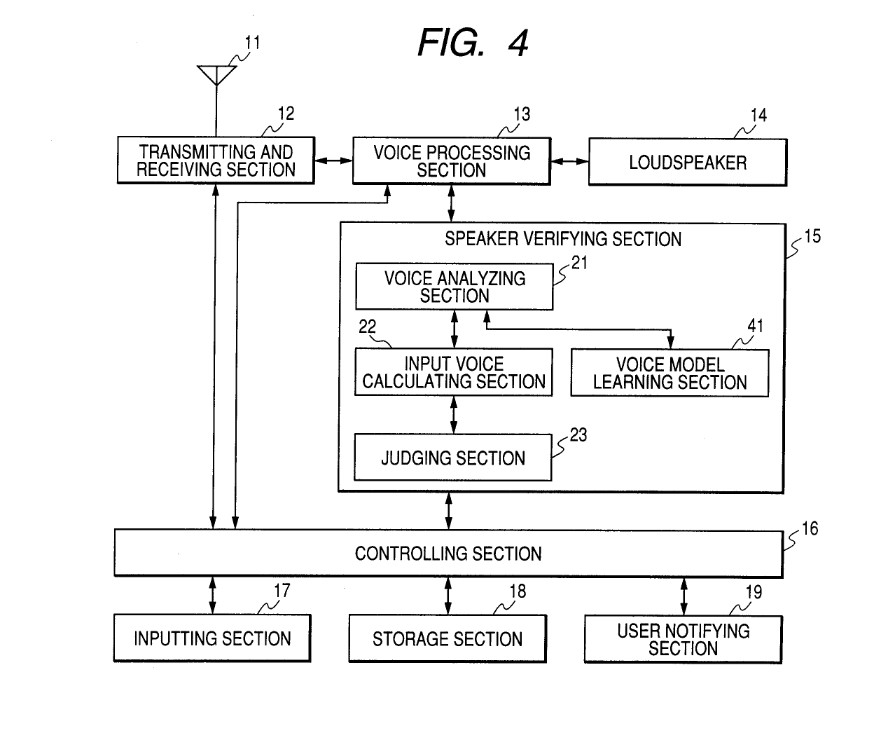

Next, a speaker collating process in the mobile terminal of the embodiment of the invention will be described with reference to a flowchart of FIG. 4. First, it is judged whether an incoming call occurs or not (step 40). If an incoming call does not occur (the case of No in step 40), the judgment on whether an incoming call occurs or not is repeated (step 41). If an incoming call occurs (the case of Yes in step 40), personal information corresponding to the telephone number of the opposite mobile terminal is obtained from the storage section 18, and the personal information is notified to the user of the present mobile terminal through the user notifying section 19 (step 42).

Next, it is judged whether the off hook button is pressed or not (step 43), and this judgment is repeated until the off hook button is pressed. If the off hook button is pressed (the case of Yes in step 43), the user is inquired whether the call partner is to be collated or not (step 44). After the inquiry, it is judged whether the user instructs to perform speaker verification or not (step 45).

If there is no instruction for performing speaker verification (the case of No in step 45), the control is returned to step 40. By contrast, if there is instructions for performing speaker verification (the case of Yes in step 45), a voice model corresponding to the telephone number of the opposite mobile terminal is read out from the storage section 18 (step 46). Furthermore, voice data of the call partner received during the call are loaded from the voice processing section 13 (step 47). On the basis of the voice model read out in step 46, the likelihood of the voice model which is produced from the voice data loaded in step 47 is calculated (step 48). It is judged whether the obtained likelihood is equal to or larger than the predetermined threshold or not (step 49).

If the obtained likelihood is equal to or larger than the predetermined threshold (the case of Yes in step 49), it is judged that the voice data of the call partner received during the call are of the owner of the opposite mobile terminal (step 50), and the result is notified to the user (step 51). By contrast, if the obtained likelihood is smaller than the predetermined threshold (the case of No in step 49), it is judged that the voice data of the call partner received during the call are not of the owner of the opposite mobile terminal (step 52), and the result is notified to the user (step 51). After it is notified whether the voice data of the call partner received during the call are of the owner of the opposite mobile terminal or not, the speaker collating process on the call partner at the present timing is ended. The above-described speaker collating process is executed each time when speaker verification is instructed by the user after an incoming call occurs.

Then, the user checks the result of speaker verification on the call partner at the present timing. When the communication is not to be continued, the user presses the on hook button to disconnect the line, and, when the communication is to be continued, the user performs no further operation. As described above, with using a previously stored voice model corresponding to the telephone number of the opposite mobile terminal, the likelihood of the voice data of the call partner received by the own mobile terminal is calculated, whereby the call partner can be identified.

In this way, according to the telephone device of the embodiment of the invention, voice data of the call partner are collated with using a previously stored voice model corresponding to the telephone number of the opposite mobile terminal, and therefore it is enabled to correctly judge whether the call partner is the owner oneself of the opposite mobile terminal or not, by using only the mobile terminal (any one of the calling mobile terminal and the called mobile terminal is enabled) possessed by the user who wishes to identify the call partner. Moreover, voice data of call partner which are received during the call are used as input voice data of speaker verification, whereby the user on the called side is enabled to identify the call partner while having a usual conversation, without making the call partner conscious of the verification.

### Second Embodiment

FIG. 4 is a block diagram schematically showing the configuration of a mobile telephone of a second embodiment of the invention.

The mobile telephone of the embodiment is different from the above-described mobile telephone of the first embodiment in that the mobile telephone includes a speaker verifying section 15 having a voice model learning section 41. Hereinafter, the voice model learning section 41 will be described.

When voice data corresponding to the telephone number of the opposite mobile terminal performing a call are not stored in the storage section 18, the voice model learning section 41 newly produces a voice model corresponding to the telephone number of the opposite mobile terminal with using voice data of the call partner which are received during the call. The controlling section 16 causes the produced new voice model to be stored into the storage section 18.

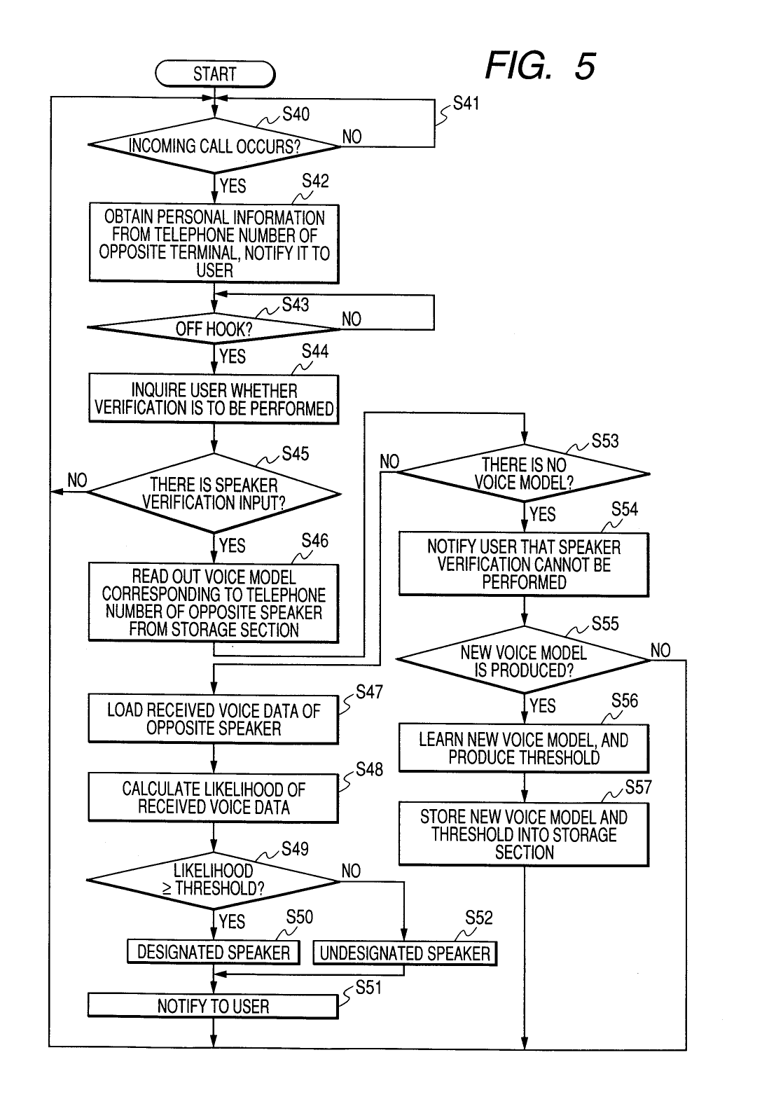

FIG. 5 is a flowchart showing a learning process in the voice model learning section 41.

In FIG. 5, the steps other than steps 40 to 51 are identical with those of the flowchart shown in FIG. 4, and therefore their description is omitted.

In the process of reading out a voice model corresponding to the telephone number of the opposite mobile terminal from the storage section 18 (step 46), it is judged whether a corresponding voice model exists in the storage section 18 or not (step 53). If a corresponding voice model exists (the case of Yes in step 53), the control advances to step 47, and, if a corresponding voice model does not exist (the case of No in step 53), the user of the own mobile terminal is notified that speaker verification cannot be performed (step 54). After the notification that speaker verification cannot be performed, it is judged whether a request to produce a new voice model is made by the user of the present mobile terminal or not (step 55).

If a request to produce a new voice model is made by the user of the present mobile terminal (the case of Yes in step 55), a voice model corresponding to the telephone number of the opposite mobile terminal is newly produced from voice data of the call partner which are received during the call, and a threshold required in comparison with the likelihood is newly produced at the same time in correspondence with the newly produced voice model (step 56). Then, the produced new voice model, and the threshold corresponding to the new voice model are stored into the storage section 18 (step 57). In this case, they are stored into the storage section 18 with being linked with personal information in the telephone directory data stored in the storage section 18. After the process is executed, the control is returned to step 40. By contrast, if a request to produce a new voice model is not made by the user of the present mobile terminal (the case of No in step 55), no further operation is performed, and the control is returned to step 30.

Here, the production of a new voice model will be described in detail.

The voice processing section 13 converts a voice of the call partner which is received by the transmitting and receiving section 12 during the call, to voice data which can be collated by the speaker verifying section 15, and inputs the data into the speaker verifying section 15. The voice analyzing section 21 extracts feature data which are required in production of a voice model, from the collatable voice data which are input from the voice processing section 13, and transfers the extracted data to the voice model learning section 41. The voice model learning section 41 produces a voice model with using the input feature data. The produced voice model is placed in the storage section 18 with being linked with personal information in the telephone directory data stored in the storage section 18.

As described above, according to the telephone device of the embodiment of the invention, in the speaker collating process, in the case where a voice model corresponding to voice data of the call partner received during a call is not stored, a voice model for the call partner is newly produced with using voice data of the call partner received during the call, and then stored. Therefore, voice data for respective new speakers can be collected without causing the user to take a trouble.

In the embodiment, when there is no voice model, a voice model is newly produced. Alternatively, even when a voice model is stored in the storage section 18, the voice model may be again produced. According to the configuration, the voice model for the call partner stored in the storage section 18 can be set to be further accurate.

In the embodiment, the case where the invention is used in a portable telephone which is one kind of communication terminal has been described. Of course, the invention can be used not only in another kind of communication terminal, but also in a fixed telephone.

In the embodiment, the process of performing verification in order that the user on the called side identifies the call partner on the calling side has been described. Similarly, also the user on the calling side can identify whether the call partner on the called side is the owner corresponding to the telephone number of the called mobile terminal, from a voice signal of the call partner on the called side.

In the embodiment, when the called mobile terminal replies to an incoming call from the calling mobile terminal, a verification execution input from the user is accepted. The invention is not restricted to this, and verification can be started at any timing.

In the above, the invention has been described in detail with reference to the specific embodiments. It is obvious to those skilled in the art that various changes and modifications may be applied without departing the sprit and scope of the invention.

The present application is based on Japanese Patent Application (No. 2004-167449) filed on Jun. 4, 2004, and its disclosure is incorporated herein by reference.

### INDUSTRIAL APPLICABILITY

According to the telephone device of the invention, voice data of the call partner are collated with using a previously stored voice model corresponding to the telephone number of the opposite mobile terminal, and therefore it is enabled to correctly judge whether the call partner is the owner oneself of the opposite mobile terminal or not, by using only the mobile terminal possessed by the user who wishes to identify the call partner. Moreover, voice data of call partner which are received during the call are used as input voice data of speaker verification, whereby the user on the called side can identify the call partner while having a usual conversation, without making the call partner conscious of the verification.

According to the telephone device of the invention, in the speaker collating process, in the case where a voice model corresponding to voice data of the call partner received during a call is not stored, a voice model corresponding to the telephone number of the opposite mobile terminal is newly produced with using voice data of the call partner received during the call, and then stored. Therefore, voice data for respective new speakers can be collected without causing the user to take a trouble.

1. A telephone device, comprising:
a storing unit configured to store a voice of each of speakers;
a speaker collating unit that verifies the voice of each of speakers with a voice of a call partner; and
a notifying unit that notifies of the speaker who coincides with the voice of the call partner by the speaker verifying unit.

2. The telephone device according to claim 1, wherein the storing unit stores the voice of each of speakers so as to correspond to a telephone number; and
wherein the speaker verifying unit verifies the voice of each of speakers corresponding to a telephone number of the call partner, with the voice of the call partner.

3. The telephone device according to claim 2, wherein the storing unit stores the voice of the call partner as the voice of each of speakers so as to correspond to the telephone number of the call partner.

4. The telephone device according to claim 3, further comprising a voice analyzing unit that extracts a featured portion from the voice of the call partner,
wherein the storing unit stores a featured portion of the voice of the call partner as a featured portion of the voice of each of speakers so as to correspond to the telephone number of the call partner; and
wherein the speaker verifying unit verifies the featured portion of the voice of each of speakers corresponding to the telephone number of the call partner, with the featured portion of the voice of the call partner.

5. The telephone device according to claim 4, wherein the speaker verifying unit includes:
an input voice calculating section that calculates a likelihood of the featured portion of the voice of the call partner on the basis of the featured portion of the voice of each of speakers; and
a judging section that judges whether the featured portion of the voice of each of speakers coincides with the featured portion of the voice of the call partner, based on a result of the calculation.
